(19) United States
(12) Patent Application Publication
(10) Pub. No.: US 2016/0328032 A1
(43) Pub. Date: Nov. 10, 2016

(54) MOUSE HAVING REDUCING-PRESSURE DECORATION PLATES

(71) Applicant: DEXIN CORPORATION, NEW TAIPEI CITY (TW)

(72) Inventor: YI-SHUN CHEN, NEW TAIPEI CITY (TW)

(21) Appl. No.: 14/707,069

(22) Filed: May 8, 2015

(51) Int. Cl. G06F 3/0354; G06F 3/038

(52) U.S. Cl. CPC G06F 3/03543; G06F 3/038; G06F 2203/0333

(57) ABSTRACT

The instant disclosure is related to a mouse, comprising a main body and a soft layer. The main body includes a roller and at least one button. The main body includes a first region and a second region, and a first recess is disposed in the first region and a second recess is disposed in the second region. The soft layer is disposed in the first recess and the second recess, in which the soft layer is a composite material comprising an elastic layer and a weaving layer. The soft layer in the second recess comprises a transparent pattern formed by laser engraving. Thereby, the mouse provided by the disclosure can provide better tactile feeling and reduce pressure of hand for reducing fatigue and damage when using the mouse for a long period.

### BACKGROUND OF THE INVENTION

1. Field of the Invention

The instant disclosure relates to a mouse; in particular, to a mouse having reducing-pressure decoration plates.

2. Description of Related Art

With development of technology, computing systems are widely used, and have become necessary tools for daily life. With the help of application programs, a computer system can not only help users to handle documents but also play multi-media files, browse the internet and store data. In general, users use a mouse to operate a computing system, for example, opening files or executing applications.

However, the convention mouse is formed of plastic materials. Thus, when a user uses the mouse in the same position for a long duration, fatigue and injury are easily generated. Therefore, it is important to develop a mouse which can provide a better touch feel and reducing pressure to the hand for reducing fatigue and injury for the users.

### SUMMARY OF THE INVENTION

In order to achieve the aforementioned objectives, according to an embodiment of the instant disclosure, a mouse is disclosed, comprising a main body having a roller and at least one button, wherein the main body comprises a first region and a second region, and a first recess is disposed in the first region and a second recess is disposed in the second region. A soft layer is disposed in the first recess and the second recess, wherein the soft layer is a composite material comprising an elastic layer and a weaving layer, and the soft layer in the second recess has a light transmissive pattern formed by laser engraving.

Preferably, the weaving layer is disposed over the elastic layer.

Preferably, the soft layer covers the at least one button.

Preferably, the weaving layer is formed by weaving yarns comprising polymer having thermal shrinkage characteristic.

Preferably, the elastic layer is silicone.

Preferably, the mouse further comprises a light emitting device disposed in the second recess of the main body, and the light emitting device is used to provide a light to pass through the light transmissive pattern formed by laser engraving for showing a light pattern.

Preferably, a top surface of the weaving layer is substantially coplanar with a top surface of the main body.

According to the description above, the application has an effect as follows. In the conventional mouse, the button and the body are formed of plastic materials. Therefore, users feel uncomfortable when using the mouse for a long duration. This disclosure arranges a soft material on a region or a plurality of regions of the body of the mouse which contact the hand the users. Furthermore, the soft material is combined with a weaving material for reducing pressure to the hand of the user. Therefore, the feel to the user is more smooth and comfortable, and fatigue and injury from using the mouse for a long duration is reduced

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 shows an exploded view of a mouse having reducing-pressure decoration plates of an embodiment of the disclosure.

FIG. 2 shows an exploded view of a mouse having pressure-reducing decoration plates of an embodiment of the disclosure at another viewing angle.

FIG. 3 shows a cross section of a soft layer of an embodiment of the disclosure.

FIG. 4 shows a three dimensional view of the mouse having reducing-pressure decoration plates of an embodiment of the disclosure.

FIG. 5 shows a three dimensional view of the mouse having reducing-pressure decoration plates of an embodiment of the disclosure at another viewing angle.

### DETAILED DESCRIPTION OF THE PREFERRED EMBODIMENTS

The aforementioned illustrations and detailed descriptions are exemplary for the purpose of further explaining the scope of the instant disclosure. Other objectives and advantages related to the instant disclosure will be illustrated in the subsequent descriptions and appended drawings.

### First Embodiment

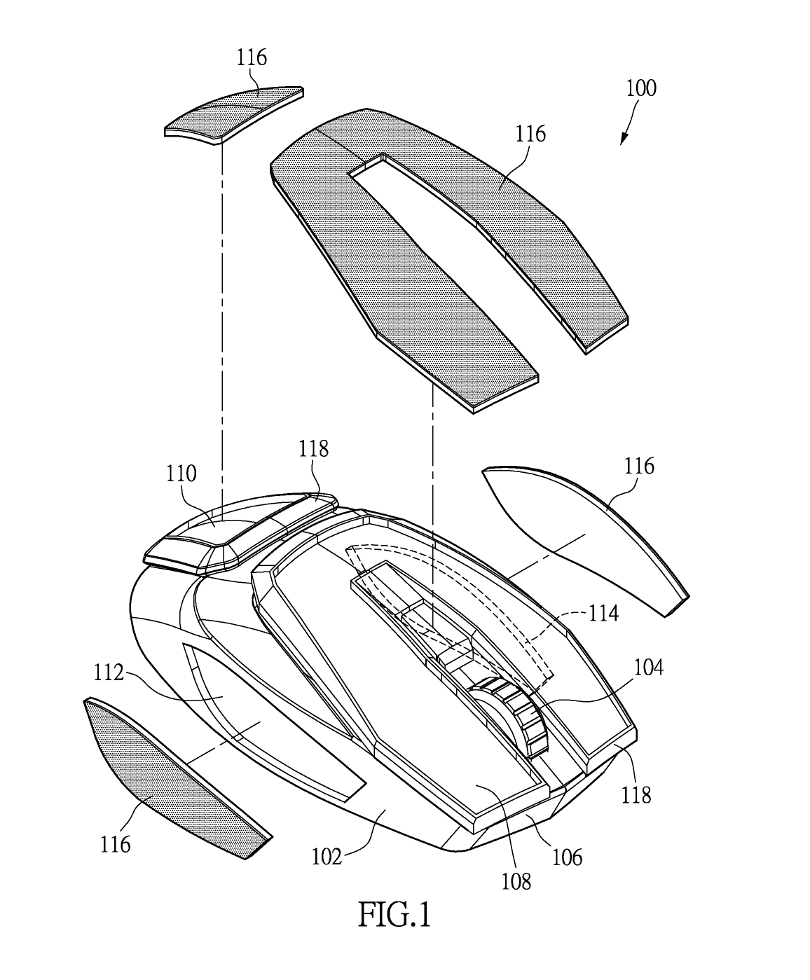

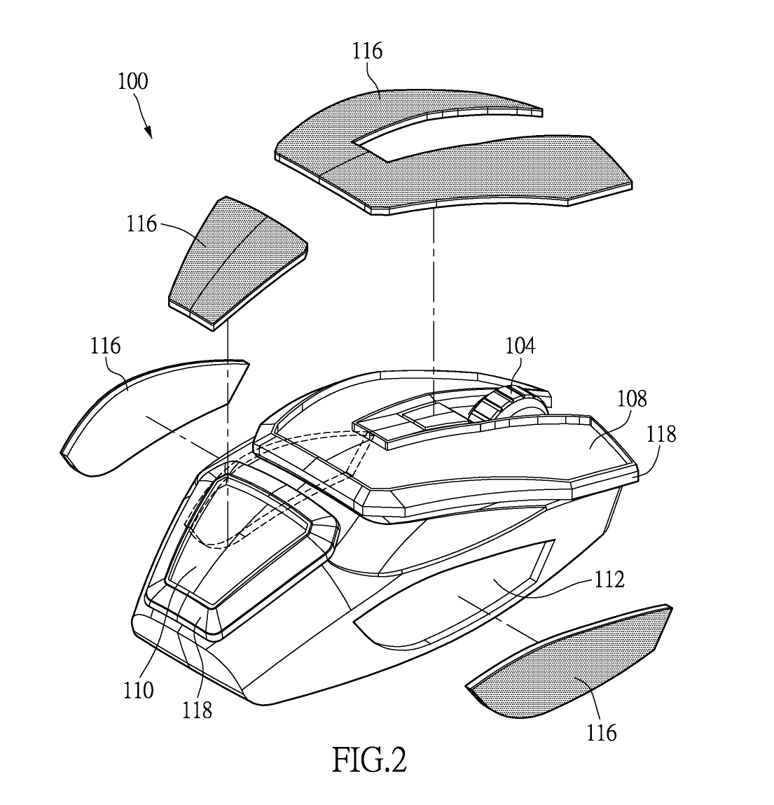

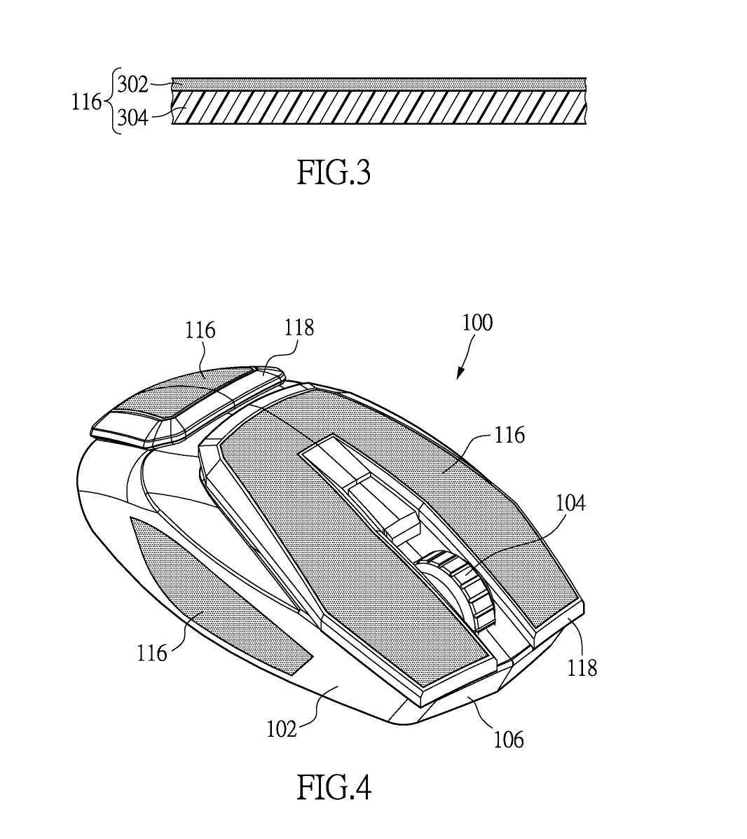

FIG. 1 shows an exploded view of a mouse having reducing-pressure decoration plates of an embodiment of the disclosure. FIG. 2 shows an exploded view of a mouse having pressure-reducing decoration plates of an embodiment of the disclosure at another viewing angle. FIG. 3 shows a cross section of a soft layer of the embodiment. Referring to FIG. 1, FIG. 2 and FIG. 3, the embodiment provides a mouse 100 having pressure-reducing decoration plates, comprising a main body 102, wherein the main body 102 can be formed by elastic materials. The main body 102 comprises a roller 104 and a button 106 therein, wherein the roller 104 can be used to move the screen when browsing windows, and the button 106 can be used to input a signal to a computing device, such as a computer. The mouse 100 can be with a wire or a wireless mouse. For a mouse having a wire, the main body 102 connects a signal line (not shown), and a terminal of the signal line can be connected to a USB plug. For a wireless mouse, the main body 102 of the mouse 100 further comprises a signal emitter, such as an infrared light emitter or bluetooth. Therefore, signals can be transmitted to the computing device through the device. The main body 102 comprises a plurality of recesses. For example, the main body 102 in FIG. 1 has four recess, which comprise a first recess 108, a second recess 110, a third recess 112 and a fourth recess 114. The main body 102 comprises a main face, side faces on the opposite sides of the main face, and a back face backwards to the main face. The first recess 108 is disposed in the main face. The second recess 110 is disposed in the back face. The third recess 112 and the fourth recess 114 are disposed in the side faces. It is noted that the number and arrangement of the recesses illustrated in FIG. 1 and FIG. 2 are only for illustration. The shape, number and location of the recesses can vary according to product specifications. For example, the recesses can be arranged according to shaping and function of the mouse and are also determined if the mouse is for a gaming purpose. The quantity, size and location of the recesses are not limited in the disclosure.

A soft layer 116 is disposed in the first recess 108, the second recess 110, the third recess 112 and the fourth recess 114. In more detail, the size and shape of the soft layer 116 matches the size and shape of the first recess 108, the second recess 110, the third recess 112 and the fourth recess 114. Therefore, the soft layer 116 can be embedded in the first recess 108, the second recess 110, the third recess 112 and the fourth recess 114. An adhesion layer can be disposed between the soft layer 116 and the main body 102, such that the soft layer 116 can be adhered in the recesses. As shown in FIG. 3, the soft layer 116 is a composite material comprising an elastic layer 304 and a weaving layer 302. The weaving layer 302 is disposed on the elastic layer 304. The weaving layer 302 is formed by weaving yarns comprising polymer having thermal shrinkage characteristic. The elastic layer 304 can be silicon having viscosity. In an embodiment, the silicon having viscosity can be permeated into the weaving layer for having better adhesion between the weaving layer 302 and the elastic layer 304. Thickness of the soft layer 116 can be 1.5 mm˜4 mm, in which thickness of the elastic layer 304 can be 1 mm˜3 mm, thickness of the weaving layer 302 can be 0.5 mm˜1 mm, and the weaving layer 302 is on the elastic layer 304.

In more detail, the soft layer 116 corresponding to the first recess 108 covers the button 106 thereunder. The purpose of this arrangement is for users to have less stress to the finger through the soft layer 116 when using the button 106 of the mouse 100 for a long duration. Furthermore, the weaving layer 302 of the soft layer 116 can make the users more comfortable when using the mouse 100. In order for the roller 104 of the mouse 100 to be not blocked by the soft layer 116, the soft layer 116 in the first recess 108 preferably is U shaped, and the notch of the U-shaped pattern corresponds to the position of the roller 104. When a user uses the mouse 100, the forefinger and the middle finger touch the soft layer 116 in the first recess 108. Therefore, the user is more comfortable and the pressure to the finger is reduced. The soft layer 116 in the second recess 110 can have a light transmissive pattern formed by laser engraving, and a light emitting device is disposed in the second recess 110 of the main body 102. Therefore, light emitted by the light-emitting device can penetrate the light transmissive pattern of the soft layer 116 in the second recess 110 to present a lightening pattern for the mouse 100 to be more beautiful. In an example, the light transmissive pattern can be a logo. The soft layer 116 in the second recess 110 can be trapezoidal. The soft layer 116 in the second recess 110 contacts the palm of the user, such that the tactile feeling for the palm to the mouse can be improved and the pressure from the mouse to the hand of the user can be reduced.

The soft layer 116 in the third recess 112 and the fourth recess 114 can be arc shaped. The soft layer 116 in the third recess 112 contacts the thumb of the right-handed user. Therefore, the soft layer 116 in the third recess 112 has advantages to improve the tactile feeling for the thumb to the mouse 100 and the pressure thereto is reduced. The soft layer 116 in the fourth recess 114 contacts the ring finger of the right-handed user. Therefore, the soft layer 116 in the fourth recess 114 has advantages to improve the tactile feeling for the ring finger to the mouse 100 and the pressure thereto is reduced.

It is noted that the mouse of the disclosure is not limited to that shown in the figures and the specification. Devices can be further added to the mouse according to its application and the shape of the main body can be changed. For example, when the mouse is used for gaming, a button can further be added to the side face, and for another example, when the mouse is used for multi media, buttons for activating the multi media can further be added to the mouse. The mouse of the embodiment can be an optical mouse, and a light emitting device (not shown) and a sensor (not shown) can be disposed at the bottom portion of the main body. A light emitted by the light emitting device is reflected by a surface of a table and is then received by a sensor. According to scanning of the light and the comparison of the light from a chip in the mouse 100, the moving direction of the mouse 100 can be obtained.

Referring to FIG. 1 and FIG. 2 again, in a example, in order to make the mouse more beautiful or fit the requirements of a process or application, a bump body 118 can be disposed on the main face and the rear face of the main body 102, and the first recess 108 and the second recess 110 can be disposed in the bump body 102 over the main face and the rear face of the main body 102. As well, the first recess 108 and the second recess 110 are not recessed in the main body 102 of the mouse 100, but are in the bump bodies 118. In a preferred example, the thickness of the soft layer 116 is the same as the depth of the corresponding recess, such that after the soft layer 116 is embedded in the recess, it does not protrude out of the recess and thus make the user feel more comfortable.

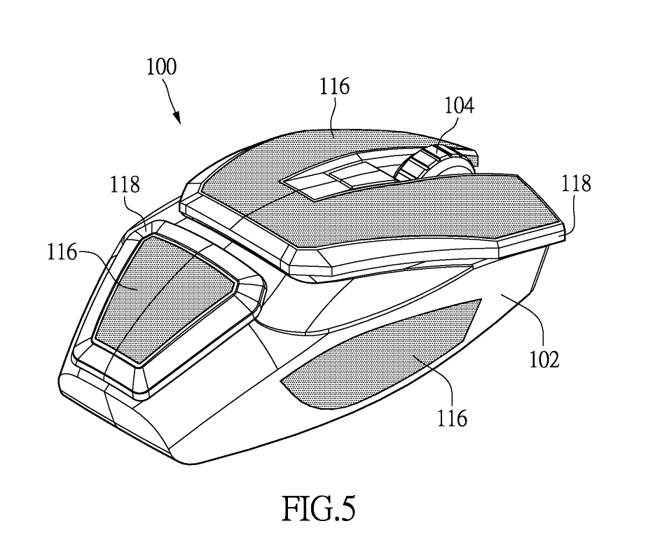

FIG. 4 shows a three dimensional view of the mouse having reducing-pressure decoration plates of an embodiment of the disclosure. FIG. 5 shows a three dimensional view of the mouse having reducing-pressure decoration plates of an embodiment of the disclosure at another view angle. Referring to FIG. 4 and FIG. 5, after the soft layer 116 is adhered in the corresponding recess, it does not protrude out of the recess. As well, as shown in FIG. 4 and FIG. 5, the top surface of the soft layer 116 is coplanar with the corresponding bump body 118 and/or the main body 102. Therefore, the feel to the user is more smooth and comfortable.

According to description above, the mouse of the disclosure have advantages as follows. In the conventional mouse, the button and the body are formed of plastic materials. Therefore, users feel uncomfortable when using the mouse for a long duration. The disclosure arranges a soft material on a region or a plurality of regions of the body of the mouse which contact the hand of the users. Furthermore, the soft material is combined with a weaving material for reducing pressure to the hand of the user. Therefore, the feel to the user is more smooth and comfortable, and fatigue and injury from using the mouse for a long duration is reduced.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. A mouse, comprising
a main body having a roller and at least one button, wherein the main body comprises a first region and a second region, and a first recess is disposed in the first region and a second recess is disposed in the second region; and
a soft layer disposed in the first recess and the second recess, wherein the soft layer is a composite material comprising an elastic layer and a weaving layer, and the soft layer in the second recess has a light transmissive pattern formed by laser engraving.

2. The mouse as recited in claim 1, wherein the weaving layer is disposed on the elastic layer.

3. The mouse as recited in claim 1, wherein the soft layer covers the at least one button.

4. The mouse as recited in claim 1, wherein the weaving layer is formed by weaving yarns comprising polymer having thermal shrinkage characteristic.

5. The mouse as recited in claim 1, wherein the elastic layer is silicone.

6. The mouse as recited in claim 1, further comprises a light emitting device disposed in the second region of the main body, and the light emitting device is used to provide a light to pass through the light transmissive pattern formed by laser engraving for showing a light pattern.

7. A mouse, comprising
a main body, wherein at least a soft layer is embedded in the main body, and the soft layer is a composite material comprising an elastic layer and a weaving layer.

8. The mouse as recited in claim 7, wherein the soft layer has a light transmissive pattern formed by laser engraving.

9. The mouse as recited in claim 8, further comprising a light emitting device under the soft layer having a light transmissive pattern formed by laser engraving.

10. The mouse as recited in claim 7, wherein the weaving layer is formed by weaving yarns comprising polymer having thermal shrinkage characteristic.

11. The mouse as recited in claim 7, wherein the elastic layer is silicone.

12. The mouse as recited in claim 7, wherein the weaving layer is on the elastic layer.

13. The mouse as recited in claim 7, wherein a top surface of the weaving layer is substantially coplanar with a top surface of the main body.
